(19) United States
(12) Patent Application Publication
(10) Pub. No.: US 2008/0158891 A1
(43) Pub. Date: Jul. 3, 2008

(54) Lamp shade support frame

(76) Inventor: Ting-Sheng Lee, Wufeng Hsiang (TW)

Correspondence Address: Troxell Law office Pllc, Suite 1404, 5205 Leesburg Pike, Falls Church, VA, 22041, US

(21) Appl. No.: 11/647,181

(22) Filed: Dec. 29, 2006

(51) Int. Cl. F21V 1/06

(52) U.S. Cl. 362/352

(57) ABSTRACT

The present invention provides an improved structure for a lamp shade support frame, structured from an upper support ring, on a lower edge of which are located a plurality of joining pieces, each having a sheath-shaped slot; a lower support ring, on which are located a plurality of hooks spaced at relative positions thereon; and a plurality of support rods joined between the upper support ring and the lower support ring. A hook hole is defined at an end of each of the support rods corresponding to the respective hooks, and a narrow inserting portion is formed at another end. Accordingly, a hook method using the hooks of the lower end and a sheath assembling method of the upper end are used when assembling the support rods, thereby shortening assembly time and reducing labor cost, as well as effectively achieving the objective of improving productivity.

### BACKGROUND OF THE INVENTION

(a) Field of the Invention

The present invention relates to an improved lamp shade structure, and more particularly to a lamp shade support structure which adopts mutual coordination between hook and sheath assembly methods to simplify assembly and realize a simple and firmer structure, thereby substantially shortening assembly time and effectively improving productivity. Moreover, after collapsing the structure, packing space is decreased and transportation cost reduced.

(b) Description of the Prior Art

Referring to FIG. 1, wherein structural configuration of a prior art lamp shade structure includes identical clasp protruding walls A located on both an upper support ring and a lower support ring, which enable easy insertion of support rods B therein when assembling the structure, using yielding space produced by crossing of the upper and lower support rings. However, the more support rods inserted, the greater the lamp shade is stretched taut, and because the support rods disable front and rear movement and insertion adjustment, thus, great effort is needed when inserting and positioning the later support rods B, resulting in an increase in labor cost and constraint on productivity. Hence, there is a need for improvement.

In light of this, the inventor of the present invention, having carried out intensive research, design and experimentation, ultimately designed a new improved structure of the present invention.

### SUMMARY OF THE INVENTION

A primary objective of the present invention is to provide an improved structure for a lamp shade support frame by adopting mutual coordination between hook and sheath assembly methods to simplify assembly and realize a simple and firmer structure, thereby substantially shortening assembly time and effectively improving productivity. Moreover, after collapsing the structure, packing space is decreased and transportation cost reduced.

In order to achieve the aforementioned objectives, the lamp shade support frame of the present invention comprises: an upper support ring disposed at an upper end edge of a lamp shade, a plurality of joining pieces are located at appropriate positions on the upper support circle, and a sheath-shaped slot is defined on each of the joining pieces; a lower support ring disposed at a lower end edge of the lamp shade, and a plurality of hooks are located on the lower support ring appropriately spaced at relative positions thereon; and a plurality of support rods joined between the upper support ring and the lower support ring, wherein a hook hole is defined at an end of each of the support rods corresponding to the respective hooks, and a narrow inserting portion is formed at another end of each of the support rods. Accordingly, a hook method using the hooks located at the lower end is used when assembling the support rods to enable easy manipulative left, right, front and rear movement and adjustment thereof, while the upper end adopts a sheath assembling method to enable the support rods to be easily inserted and assembled within the slots of the joining pieces. Effective coordination between the upper and lower end assembly methods shortens assembly time and reduces labor cost, and also effectively achieves the objective of improving productivity.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view of a prior art structure.

FIG. 2 shows an assembled elevational view of a support frame according to the present invention.

FIG. 3 shows an exploded schematic view according to the present invention.

FIG. 4 shows a schematic view of a lamp shade according to the present invention.

FIG. 4a shows a partial enlarged view of a joining piece of the lamp shade according to the present invention.

FIG. 4b shows a partial enlarged view of a hook of the lamp shade according to the present invention.

FIG. 5 shows a partial cutaway view of the lamp shade according to the present invention.

FIG. 6 shows schematic views depicting assembly of support rods according to the present invention.

FIG. 7 shows a schematic view of the support rod inserted and fixedly positioned according to the present invention.

FIG. 7a shows a partial enlarged view depicting assembly of the support rod and the joining piece according to the present invention.

FIG. 8 shows a schematic view of the support rod inserted and fixedly positioned according to the present invention.

FIG. 8a shows a partial enlarged view depicting assembly of the support rod and the hook according to the present invention.

FIG. 9 shows an elevational schematic view depicting lateral insertion of the support rods when assembling according to the present invention.

FIG. 9a shows a partial enlarged view depicting lateral insertion of the support rods when assembling according to the present invention.

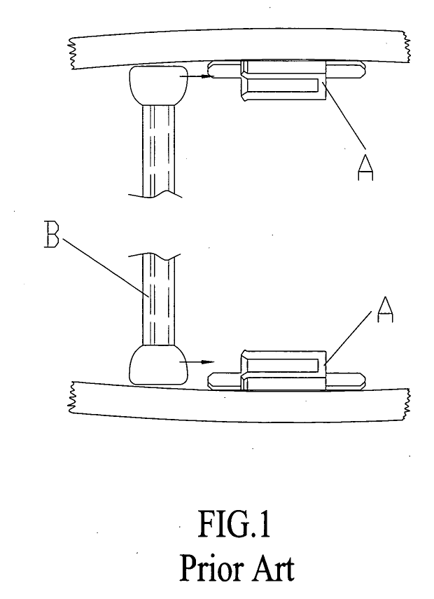

### DETAILED DESCRIPTION OF THE PREFERRED EMBODIMENTS

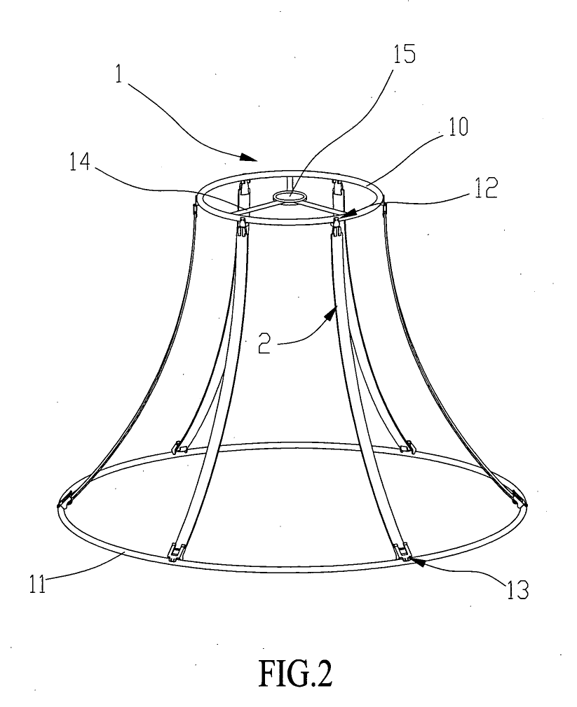

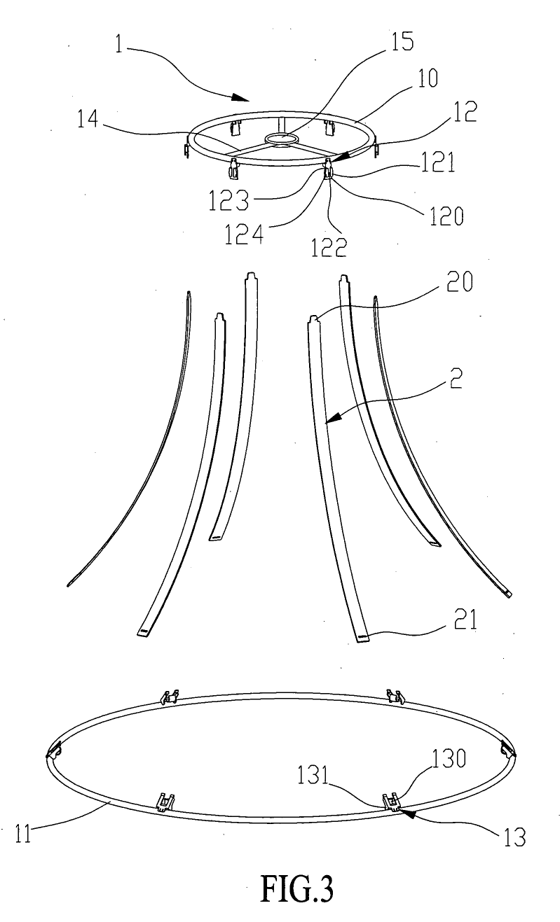

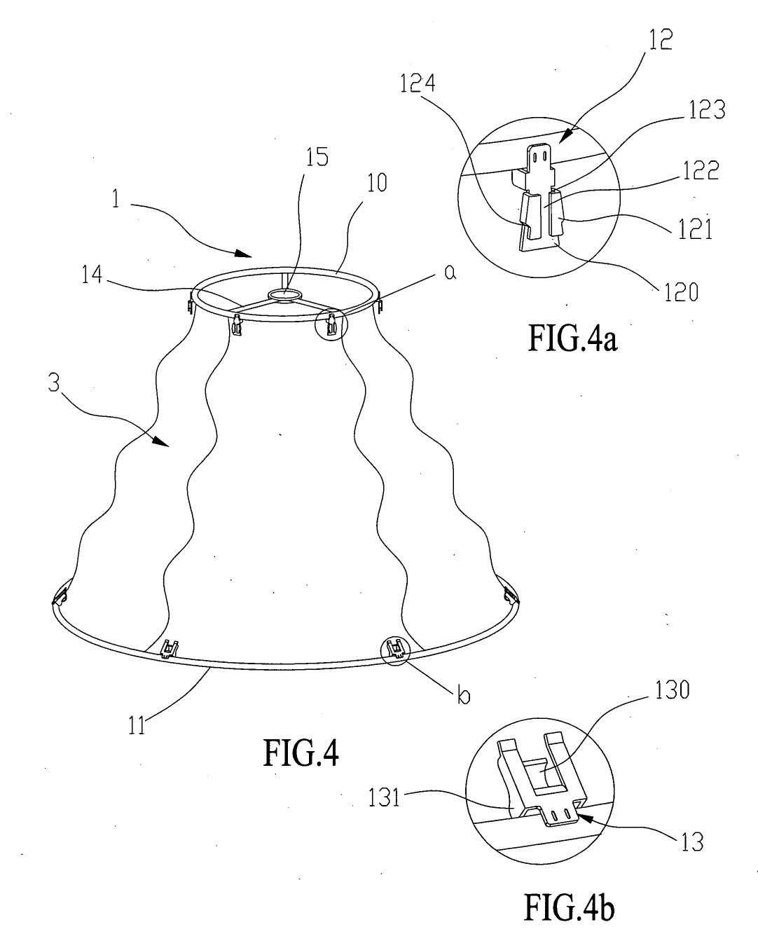

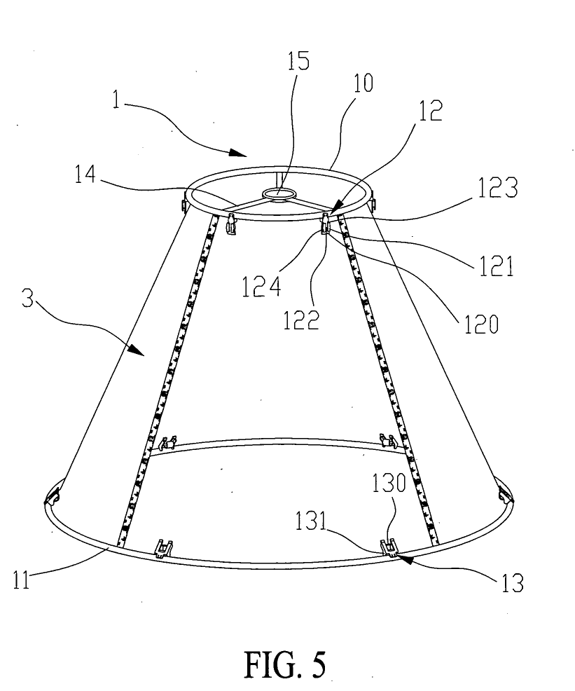

Referring to FIGS. 2˜8a, which show an improved structure of the present invention, comprising:

An upper support ring 10 disposed at an upper end edge of a lamp shade 1, wherein a plurality of joining pieces 12 are located at appropriate positions on the upper support circle 10. A sheath-shaped slot 122 is defined on each of the joining pieces 12.

A lower support ring 11 disposed at a lower end edge of the lamp shade 1, wherein a plurality of hooks 13 are located on the lower support ring 11 appropriately spaced at relative positions thereon.

A plurality of support rods 2 joined between the upper support ring 10 and the lower support ring 11, wherein a hook hole 21 is defined at an end of each of the support rods 2 corresponding to the respective hooks 13, and a narrow inserting portion 20 is formed at another end of each of the support rods 2.

An embodiment of the present invention comprises struts 14 spaced and inwardly configured on the support ring 10 by contiguous joining to a central inner ring 15, and each of the joining pieces 12 are formed from a folded single piece of metallic shell-shaped body, within which is provided a relatively long tongue piece 120, and two relatively short side pieces 121 are folded back towards the center to form a ladder-shaped folded enclose portion 123, thereby ensuring the inserting portions 20 of the support rods 2 do not fall out after inserting therein. Each of the hooks 13 is provided with a concave base 131, on an opening of which is located a foldable portion 130, which folds and closes the opening after inserting the support rod 2 therein, thereby ensuring the support rods 2 do not fall out.

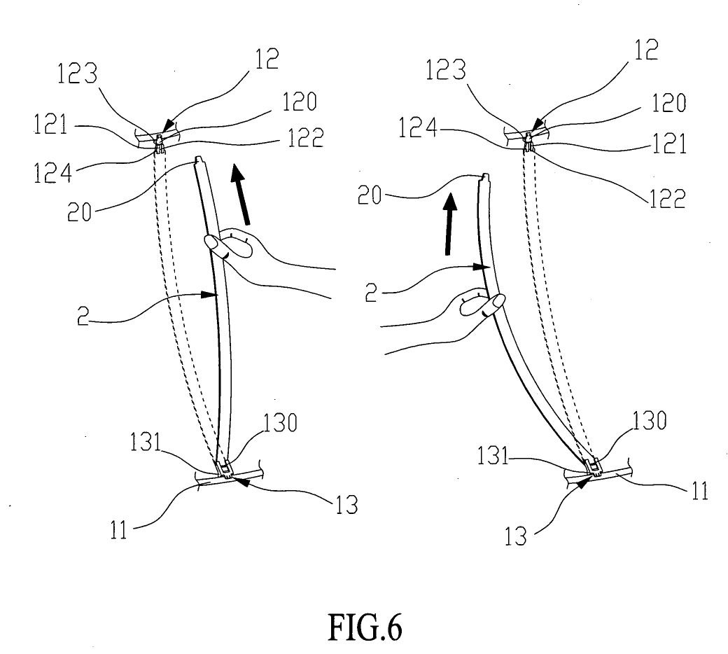

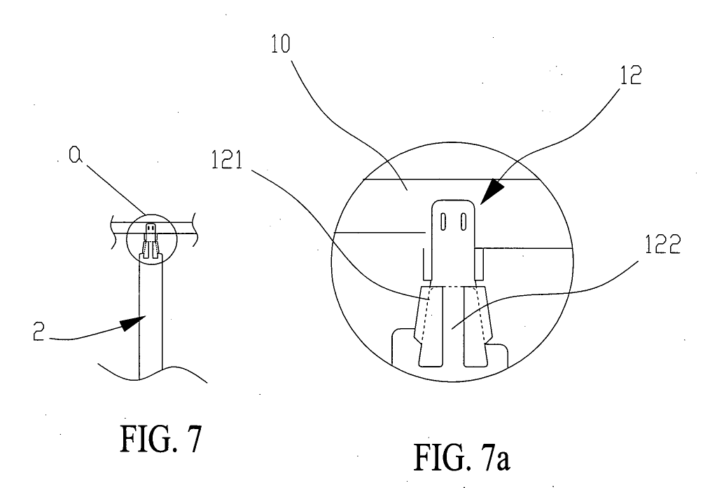

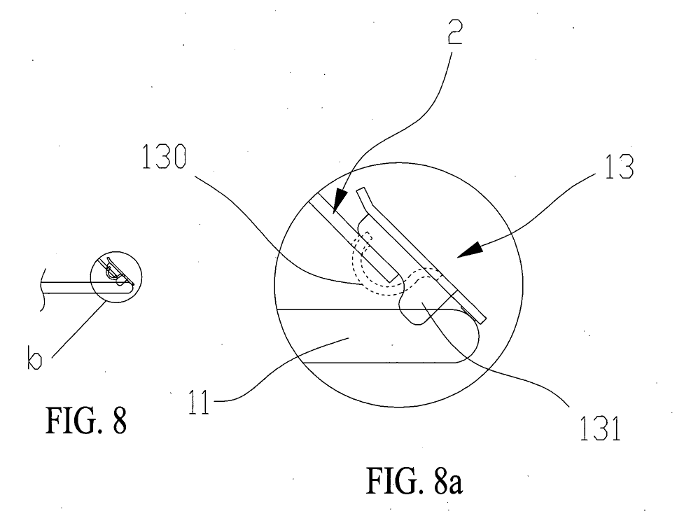

Accordingly, referring to FIGS. 6˜8a, a hook method using the hooks 13 located at the lower end of the entire structure is used when assembling the support rods 2 to enable easy manipulative left, right, front and rear movement and adjustment thereof, while the upper end adopts a sheath assembling method to enable the support rods 2 to be easily inserted and assembled within the slots 122 of the joining pieces 12. Effective coordination between the upper and lower end assembly methods enables fast assembly and optimum fixing effectiveness, which is not only able to shorten assembly time and reduce labor cost, but also effectively achieves the objective of improving productivity.

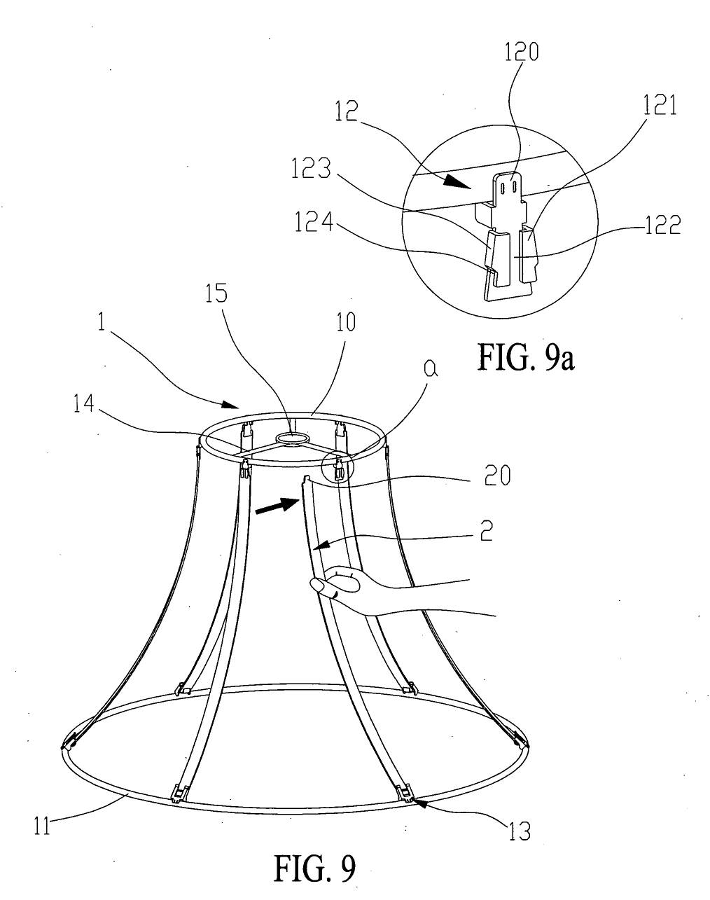

Referring to FIG. 9 and FIG. 9a, in order to enable simple and convenient assembly, a gap 124 is additionally defined between the tongue piece 120 of each lip of the slots 122 and the folded enclose portion 123 of the entire configuration of each of the joining pieces 12, thereby further expediting assembly of the support rods 2 by enabling respective sliding into the slots 122 from sides of the gaps 124. It is understood that it may be chosen to only define the gaps 124 on a single side, thus enabling blocking the other sides to limit positioning whereby the support rods 2 are prevented from over sliding the slots 122 when inserting therein.

Referring again to FIGS. 2˜5, soft material of a lamp shade fabric 3 facilitates collapsing and storing away of the structural design of the entire configuration and reduces bulkiness, thereby effectively controlling space occupied by components for transportation, reducing material cost and saving on freight thereof. Moreover, when the support frame is unfolded and pulled taut, each portion is tightly joined together, thereby ensuring product quality and assembly strength, moreover, the support frame will not come apart or easily deform.

In conclusion, the lamp shade support frame of the present invention simplifies assembly and realizes a simple and firmer structural configuration, thereby substantially shortening assembly time and effectively improving productivity. Moreover, the present invention surpasses the prior art in functionality, and is provided with advancement and operating usage value. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A lamp shade support frame, comprising:
an upper support ring disposed at an upper end edge of a lamp shade, a plurality of joining pieces are located at appropriate positions on a lower edge of the upper support circle, and a sheath-shaped slot is defined on each of the joining pieces;
a lower support ring disposed at a lower end edge of the lamp shade, a plurality of hooks are located on the lower support ring appropriately spaced at relative positions thereon; and
a plurality of support rods joined between the upper support ring and the lower support ring, a hook hole is defined at an end of each of the support rods corresponding to the respective hooks, and a narrow inserting portion is formed at another end of each of the support rods;
whereby mutual coordination between hook and sheath assembly methods is used to enable manipulative left, right, front and rear movement and adjustment and easy insertion of the support rods when assembling, and effectively shortening assembly time.

2. The lamp shade support frame according to claim 1, wherein the joining piece is formed from a folded single piece of metallic shell-shaped body, within which is provided a relatively long tongue piece, and two relatively short side pieces are folded back towards the center to form a ladder-shaped folded enclose portion; moreover, each of the hooks is provided with a concave base, on an opening of which is located a foldable portion, which folds and closes the opening after inserting the support rod therein.

3. The lamp shade support frame according to claim 2, wherein a gap is defined between the tongue piece of a lip of the slot and the folded enclose portion.
